(19) United States
(12) Patent Application Publication
(10) Pub. No.: US 2011/0071849 A1
(43) Pub. Date: Mar. 24, 2011

(54) SYSTEM AND METHOD FOR OBTAINING MEDICAL RECORDS

(76) Inventor: Ken H. Rosenfeld, Pittsford, NY (US)

(21) Appl. No.: 12/562,395

(22) Filed: Sep. 18, 2009

(51) Int. Cl. G06Q 50/00

(52) U.S. Cl. 705/3

(57) ABSTRACT

A method and computer program product for obtaining a first medical record for a first patient from a first image provider within a health information exchange, and obtaining a second medical record for a second patient from a second image provider within the health information exchange. The availability of the first medical record and the second medical record is enabled to a medical services provider.

### TECHNICAL FIELD

This disclosure relates to medical records and, more particularly, to the management of medical records.

### BACKGROUND

Patients are often treated by a multiplicity of medical professionals. For example, a patient may use a general practitioner for routine medical care. Additionally, the patient may use several specialized practitioners to treat various ailments. Examples of such specialized practitioners may include but are not limited to neurologists, cardiologists, and oncologists.

Often, when a patient is referred to a specialized practitioner from a general practitioner, the specialized practitioner may request a copy of the various medical records concerning the patient. For example, if the general practitioner referred the patient to a cardiologist due to the patient failing a stress test, the cardiologist may request a copy of the medical records associated with the stress test so that the patient does not have to undergo duplicative testing procedures.

Typically, the responsibility of obtaining copies of the patient's medical records is often placed on an administrator or assistant within the office of the specialized practitioner. Unfortunately, this task often proves difficult due to the high existing workloads of administrators/assistants and the lack of existing business relationships between the office of the specialized practitioner and the office of the general practitioner.

The responsibility for obtaining copies of the patient's medical records may also fall on the patient. This can cause significant additional stress to the patient, particularly since it is during a time of ill health. Furthermore, patients typically do not have the training to validate that the records they are collecting are the correct ones, and if they show up at the specialized practitioner without their records, or the incorrect ones, they may have to cancel the appointment and reschedule, causing further stress to the patient, and unrecoverable costs to the specialist.

### SUMMARY OF DISCLOSURE

In one implementation of this disclosure, a computer-implemented method includes obtaining a first medical record for a first patient from a first image provider within a health information exchange, and obtaining a second medical record for a second patient from a second image provider within the health information exchange. The availability of the first medical record and the second medical record is enabled to a medical services provider.

One or more of the following features may be included. The medical services provider may be required to authenticate their identity. Enabling the availability may include enabling the availability of an electronic view of the first medical record and an electronic view of the second medical record to the medical services provider. The electronic view of the first medical record may be streamed to the medical services provider. The electronic view of the second medical record may be streamed to the medical services provider.

Obtaining the first medical record for the first patient may include retrieving the first medical record for the first patient via a first image server of the first image provider. Obtaining the second medical record for the second patient may include retrieving the second set of medical records for the second patient via a second image server of the second image provider.

A request for a third medical record for a third patient from a third image provider within the health information exchange may be received. The request for the third medical record for the third patient from the third image provider within the health information exchange may be processed. The third medical record for the third patient from the third image provider within the health information exchange may be obtained. The availability of the third medical record to the medical services provider may be enabled. One or more of the first and second medical records may be an image-based medical record. The medical services provider may be chosen from the group consisting of: a general clinician; and a specialized clinician.

In another implementation of this disclosure, a computer program product resides on a computer readable medium and has a plurality of instructions stored on it. When executed by a processor, the instructions cause the processor to perform operations including obtaining a first medical record for a first patient from a first image provider within a health information exchange, and obtaining a second medical record for a second patient from a second image provider within the health information exchange. The availability of the first medical record and the second medical record is enabled to a medical services provider.

One or more of the following features may be included. The medical services provider may be required to authenticate their identity. Enabling the availability may include enabling the availability of an electronic view of the first medical record and an electronic view of the second medical record to the medical services provider. The electronic view of the first medical record may be streamed to the medical services provider. The electronic view of the second medical record may be streamed to the medical services provider.

Obtaining the first medical record for the first patient may include retrieving the first medical record for the first patient via a first image server of the first image provider. Obtaining the second medical record for the second patient may include retrieving the second set of medical records for the second patient via a second image server of the second image provider.

A request for a third medical record for a third patient from a third image provider within the health information exchange may be received. The request for the third medical record for the third patient from the third image provider within the health information exchange may be processed. The third medical record for the third patient from the third image provider within the health information exchange may be obtained. The availability of the third medical record to the medical services provider may be enabled. One or more of the first and second medical records may be an image-based medical record. The medical services provider may be chosen from the group consisting of: a general clinician; and a specialized clinician.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a record management process executed in whole or in part by a computer coupled to a distributed computing network;

FIG. 2 is a flowchart of the record management process of FIG. 1;

FIG. 3 is a diagrammatic view a personal digital assistant configured to access the record management process of FIG. 1; and

FIG. 4 is a diagrammatic view of a cellular telephone configured to access the record management process of FIG. 1.

### DETAILED DESCRIPTION OF THE PREFERRED EMBODIMENTS

### System Overview:

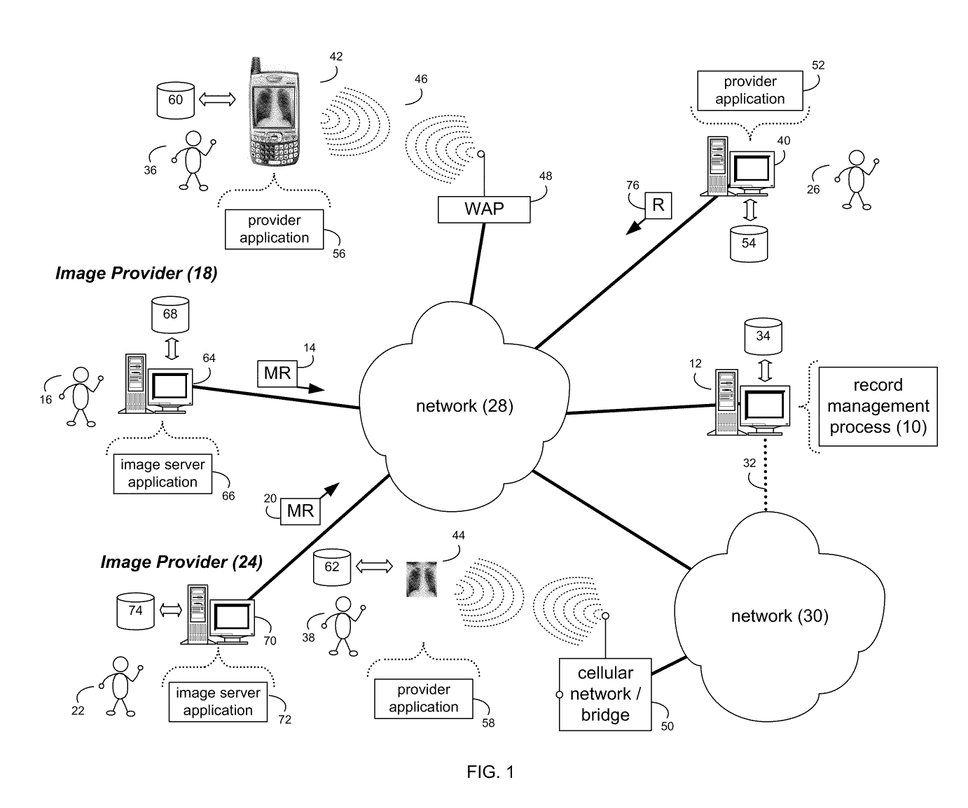

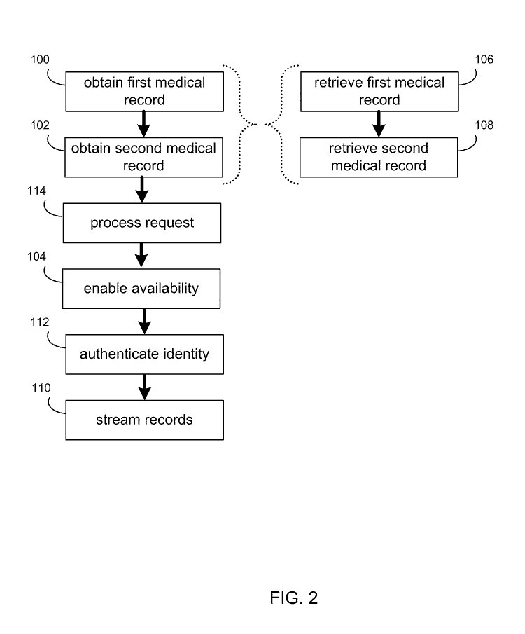

Referring to FIGS. 1 & 2, there is shown a record management process 10, which may be a server-based application resident on (in whole or in part) and executed by (in whole or in part) management computer 12 (e.g., a single server computer, a plurality of server computers, or a general purpose computer, for example). As will be discussed below in greater detail, record management process 10 may obtain 100 first medical record 14 for first patient 16 from first image provider 18 within a health information exchange. Record management process 10 may obtain 102 second medical record 20 for second patient 22 from second image provider 24 within the health information exchange. Examples of first and second medical records 14, 20 may include but are not limited to image-based medical records. Record management process 10 may enable 104 the availability of first medical record 14 and the second medical record 16 to medical services provider 26.

Management computer 12 may be coupled to network 28 (e.g., the Internet). Management computer 12 may be, for example, a web server running a network operating system, examples of which may include but are not limited to Microsoft Windows 2008 Server™, or Redhat Linux™.

Management computer 12 may also execute a web server application, examples of which may include but are not limited to Microsoft IIS™, or Apache Webserver™, that allows for HTTP (i.e., HyperText Transfer Protocol) or HTTPS (i.e. Hypertext Transfer Protocol Secure) access to management computer 12 via network 28. Network 28 may be coupled to one or more secondary networks (e.g., network 30), such as: a local area network; a wide area network; or an intranet, for example. Additionally/alternatively, management computer 12 may be coupled to network 28 through secondary network 30, as illustrated with link line 32 (shown in phantom).

The instruction sets and subroutines of record management process 10, which may be stored on a storage device 34 coupled to management computer 12, may be executed by one or more processors (not shown) and one or more memory architectures (not shown) incorporated into management computer 12. Storage device 34 may include but is not limited to a hard disk drive, a tape drive, an optical drive, a RAID array, a random access memory (RAM), or a read-only memory (ROM).

Medical services provider 26 (or additional medical services providers 36, 38) may access record management process 10 (directly through network 28 or through secondary network 30) using various client electronic devices, examples of which may include but are not limited to: provider computer 40, personal digital assistant 42, data-enabled cellular telephone 44, laptop computers (not shown), and dedicated network appliances (not shown), for example. Examples of medical services providers 26, 36, 38 may include but are not limited to general clinicians and specialized clinicians.

The various client electronic devices may be directly or indirectly coupled to network 28 (or network 30). For example, provider computer 40 is shown directly coupled to network 28 via a hardwired network connection. Further, personal digital assistant 42 is shown wirelessly coupled to network 28 via a wireless communication channel 46 established between personal digital assistant 42 and wireless access point (i.e., WAP) 48, which is shown directly coupled to network 28. Additionally, cellular telephone 44 is shown wirelessly coupled to cellular network/bridge 50, which is shown directly coupled to network 30.

WAP 48 may be, for example, an IEEE 802.11a, 802.11b, 802.11g, 802.11n, Wi-Fi, and/or Bluetooth device that is capable of establishing secure communication channel 46 between personal digital assistant 42 and WAP 48.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Client Software:

Provider computer 40 may execute provider application 52, examples of which may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™), and a specialized interface that allows e.g., medical services provider 26 to access and configure record management process 10, view (to be discussed below) first medical record 14 and/or second medical record 20, and request additional medical records. Provider computer 40 may execute an operating system, examples of which may include but are not limited to Microsoft Windows Vista™ or Redhat Linux™.

The instruction sets and subroutines of provider application 52, which may be stored on a storage device 54 coupled to provider computer 40, may be executed by one or more processors (not shown) and one or more memory architectures (not shown) incorporated into provider computer 40. Storage device 54 may include but is not limited to a hard disk drive, a tape drive, an optical drive, a RAID array, a random access memory (RAM), or a read-only memory (ROM).

Personal digital assistant 42 and/or cellular telephone 44 may execute provider applications 56, 58 (respectively), examples of which may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™), or a specialized interface that allows e.g., medical services providers 36, 38 (respectively) to access and configure record management process 10, view (to be discussed below) first medical record 14 and/or second medical record 20, and request additional medical records.

Personal digital assistant 42 and/or cellular telephone 44 may execute an operating system, examples of which may include but are not limited to Microsoft Windows Mobile™, Redhat Linux™, Palm OS™, iPhone, or a device-specific (i.e., custom) operating system.

The instruction sets and subroutines of provider applications 56, 58, which may be stored on a storage device 60, 62 (respectively) coupled to personal digital assistant 42 and/or cellular telephone 44 (respectively), may be executed by one or more processors (not shown) and one or more memory architectures (not shown) incorporated into personal digital assistant 42 and/or cellular telephone 44. Storage device 60, 62 may include but are not limited to a hard disk drive, a tape drive, an optical drive, a RAID array, a random access memory (RAM), a read-only memory (ROM) a Compact Flash (CF) card, a Secure Digital (SD) card, a SmartMedia card, a Memory Stick, and a MultiMedia card, for example.

First image provider 18 may provide first medical record 14 for first patient 16 to management computer 12 via first image server 64. First image server 64 may execute image server application 66 that effectuates the transfer of first medical record 14 to management computer 12 (via network 28 and/or network 30). First image server 64 may execute an operating system, examples of which may include but are not limited to Microsoft Windows Vista™ or Redhat Linux™.

The instruction sets and subroutines of image server application 66, which may be stored on a storage device 68 coupled to first image server 64, may be executed by one or more processors (not shown) and one or more memory architectures (not shown) incorporated into first image server 64. Storage device 68 may include but is not limited to a hard disk drive, a tape drive, an optical drive, a RAID array, a random access memory (RAM), or a read-only memory (ROM).

Second image provider 24 may provide second medical record 20 for second patient 22 to management computer 12 via second image server 70. Second image server 70 may execute image server application 72 that effectuates the transfer of second medical record 20 to management computer 12 (via network 28 and/or network 30). Second image server 70 may execute an operating system, examples of which may include but are not limited to Microsoft Windows Vista™ or Redhat Linux™.

The instruction sets and subroutines of image server application 72, which may be stored on a storage device 74 coupled to second image server 70, may be executed by one or more processors (not shown) and one or more memory architectures (not shown) incorporated into second image server 70. Storage device 74 may include but is not limited to a hard disk drive, a tape drive, an optical drive, a RAID array, a random access memory (RAM), or a read-only memory (ROM).

### Record Management Process:

As discussed above, record management process 10 may obtain 100 first medical record 14 for first patient 16 from first image provider 18 within a health information exchange. Record management process 10 may obtain 102 second medical record 20 for second patient 22 from second image provider 24 within the health information exchange. Record management process 10 may enable 104 the availability of first medical record 14 and second medical record 16 to medical services provider 26.

For illustrative purposes, assume that first image provider 18 is a medical image service provider that provides x-ray image services. Further assume that first patient 16 is being treated by medical services provider 26, who referred patient 16 to first image provider 18 for x-ray services. Accordingly, x-ray images of first patient 16 were generated. These x-ray images may be in a native digital format or converted into a digital format. Once digitized, these x-ray images (in the form of first medical record 14) may be provided (via network 28 and/or network 30) to management computer 12 via first image server 64 that (as discussed above) executes image server application 66.

The manner in which first medical record 14 is provided to management server 12 may vary depending on the way in which record management process 10 and/or image server application 66 is configured. For example, once digitized, first medical record 14 may be placed into a queue resident on/accessible by e.g., first image server 64. First medical record 14 may only be provided to management server 12 (and record management process 10) upon record management process 10 retrieving 106 first medical record 14. Accordingly, record management process 10 and/or image server application 66 may be configured in a “pull” fashion, in that record management process 10 pulls information (i.e., first medical record 14) from first image server 64.

Alternatively, once digitized, first image server 64 may provide first medical record 14 to management server 12 (and record management process 10) without record management process 10 needing to request first medical record 14. Accordingly, record management process 10 and/or image server application 66 may be configured in a “push” fashion in that the information (i.e., first medical record 14) is pushed from first image server 64 to record management process 10.

For illustrative purposes, assume that second image provider 24 is a medical image service provider that provides MRI image services. Further assume that second patient 22 is being treated by medical services provider 36, who referred patient 22 to second image provider 24 for MRI services. Accordingly, MRI images of second patient 22 were generated. These MRI images may be in a native digital format or converted into a digital format. Once digitized, these MRI images (in the form of second medical record 20) may be provided (via network 28 and/or network 30) to management computer 12 via second image server 70 that (as discussed above) executes image server application 72.

The manner in which second medical record 20 is provided to management server 12 may vary depending on the way in which record management process 10 and/or image server application 72 is configured. For example, once digitized, second medical record 20 may be placed into a queue resident on/accessible by e.g., second image server 72. Second medical record 20 may only be provided to management server 12 (and record management process 10) upon record management process 10 retrieving 108 second medical record 20. Accordingly, record management process 10 and/or image server application 72 may be configured in a “pull” fashion, in that record management process 10 pulls information (i.e., second medical record 20) from second image server 70.

Alternatively, once digitized, second image server 70 may provide second medical record 20 to management server 12 (and record management process 10) without record management process 10 needing to request second medical record 20. Accordingly, record management process 10 and/or image server application 72 may be configured in a “push” fashion in that the information (i.e., second medical record 20) is pushed from second image server 70 to record management process 10.

Once record management process 10 obtains 100, 102 medical records 14, 20, record management process 10 may store medical records 14, 20 on e.g., storage device 34 coupled to management computer 12.

Once e.g., medical records 14, 20 are available via record management process 10, medical services providers 26, 36, 38 may access medical records 14, 20. For example, record management process 10 may enable 104 the online availability of an electronic view of first medical record 14 and an electronic view of second medical record 20 to e.g., medical services providers 26, 36, 38. For example, an electronic view of first medical record 14 and/or second medical record 20 may be streamed 110 to the medical services providers (e.g., medical services providers 26, 36, 38) from management computer 12.

Prior to accessing medical records 14, 20, medical services providers 26, 36, 38 may be required to authenticate 112 their identity. For example, medical services provider 26 may be required to provide record management process 10 with one or more unique identifiers assigned to medical services provider 26, examples of which may include but are not limited to an account number, a customer number, a password, and a PIN (i.e., personal identification number) code, for example. For example, upon submitting an electronic request 76 to record management process 10, medical services provider 26 may be required to enter a confidential customer number.

Electronic request 76 may be prepared by medical services provider 26 via provider application 52. As discussed above, examples of provider application 52 may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™), or a specialized interface. When preparing request 76, an electronic request template (not shown and populatable by provider application 52) may be used to define the data fields required for a complete request. For example, the electronic request template may include a patient name field, a patient address field, a patient social security number field, a patient birth date field, and a requested medical records field, for example.

Additionally, when contacting data management process 10, medical services providers 26, 36, 38 may be required to provide sufficient information to identify the patient in question and the specific medical records desired. For example, medical services provider 26 may provide record management process 10 with e.g., the name of the patient, the address of the patient, the social security number of the patient and/or the birth date of the patient, for example. Additionally, medical services provider 26 may define the specific medical records desired from record management process 10.

Continuing with the above stated example, assume that medical services provider 26 requests (via electronic request 76) medical records 14, 20 from record management process 10. Upon receiving electronic request 76, data management process 10 may process 114 (e.g., approve/reject) electronic request 76.

If approved, data management process 10 may enable 104 medical services provider 26 to access first medical record 14 and the second medical record 20. For example, data management process 10 may provide medical services provider 26 with a secure link (e.g., a uniform resource locator) that allows medical services provider 26 to access first medical record 14 and the second medical record 20. Alternatively, first medical record 14 and the second medical record 20 may be added to a list of medical records accessible to medical services provider 26, as defined within a secure remotely-accessible common directory within management computer 12. Further and as discussed above, management computer 12 may execute a web server application that allows for HTTP or HTTPS access to management computer 12 via networks 28, 30. Accordingly, management computer 12 may serve a web-based portal (not shown) for medical services provider 26. Therefore, access to medical records 14, 20 may be effectuated via this web-based portal (not shown). When accessing the web-based portal (not shown), medical services provider 26 may be presented with a plurality of links (e.g., uniform resource locators) that point to various medical records available for various patients. For example, the web-based portal (not shown) may include a first link that allows medical services provider 26 to access first medical record 14 and a second link that allows medical services provider 26 to access second medical record 20.

Once medical records 14, 20 are accessible by medical services provider 26, the manner in which medical services provider 26 obtains the requested medical records (e.g., medical records 14, 20) may vary depending on the manner in which data management process 10 is configured. For example, data management process 10 may be configured to allow medical services provider 26 to download a copy of the requested medical records (e.g., medical records 14, 20) from management computer 12 to e.g., provider computer 40.

Alternatively, downloading may be prohibited and data management process 10 may be configured to only allow the requested medical records (e.g., medical records 14, 20) to be streamed 110 from management computer 12 to e.g., provider computer 40. Specifically, by prohibiting the downloading of the medical records (e.g., medical records 14, 20) and only allow the user of data management process 10 to view the remotely-stored medical records (e.g., medical records 14, 20), the security and privacy of the medical records (e.g., medical records 14, 20) is enhanced. Typically, when the requested medical records (e.g., medical records 14, 20) are streamed 110 from e.g., management computer 12 to provider computer 40, only a real-time view of the medical records is provided to provider computer 40, and a copy of the requested medical records (e.g., medical records 14, 20) is never downloaded directly to provider computer 40. Examples of a provider application (e.g., provider applications 52, 56, 58) that allow for such data streaming 110 may include, but are not limited to: Citrix Access Gateway™ available from Citrix Systems™ of Fort Lauderdale, Fla.; and eHealthViewer™ available from eHealth Global Technologies, Inc. of Rochester, N.Y.

When streaming 110 the requested medical records (e.g., medical records 14, 20) from e.g., management computer 12 to provider computer 40, the resolution of the image streamed may be initially reduced to the maximum resolution of the device upon which the user is viewing the image or the resolution of the application window through which the user is viewing the image. For example, if the resolution of an image included within medical record 20 is 2,048×2,048 pixels and this image is being streamed to and viewed on personal digital assistant 42 (which has a maximum screen resolution of 320×320 pixels), the resolution of the image included within medical record 20 may be reduced to 320×320 pixels to allow for faster viewing of the image. However, through the use of provider application 56, medical services provider 36 may be able to zoom in on a specific portion of the image included within medical record 20 and that portion of the image may be provided in the original resolution of the image.

Data management process 10 may be configured to process the requested medical records (e.g., medical records 14, 20) prior to streaming 110 the requested information from e.g., management computer 12 to provider computer 40. For example, assume that the image included within medical record 20 includes a plurality of discrete images representative of individual slices within a three-dimensional MRI image. Accordingly and through the use of provider application 56, medical services provider 36 may be able to request that data management process 10 assemble those discrete individual slices into a three-dimensional MRI image. Accordingly, data management process 10 and management computer 12 may perform the necessary processing to generate the three-dimensional MRI image and then a view of that three-dimensional MRI image may be streamed to personal digital assistant 42 of medical services provider 36. Therefore, personal digital assistant 42 is not required to do the processor-intensive calculations required to generate the three-dimensional image, thus allowing for the use of light-weight client devices.

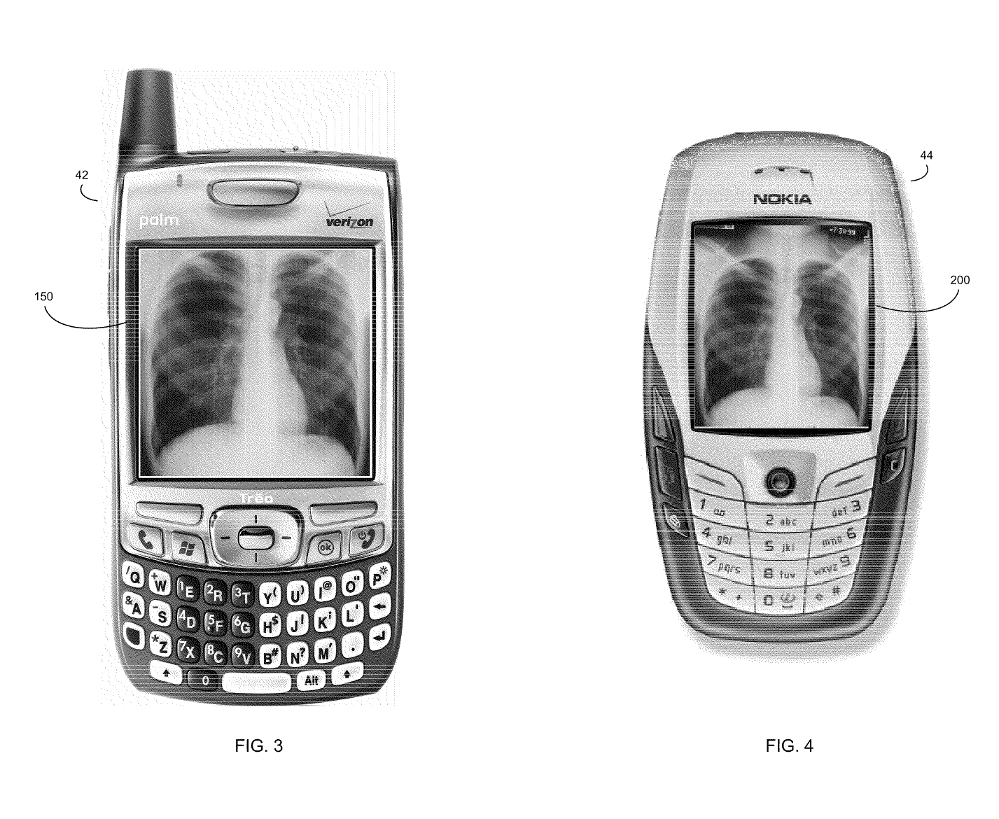

In addition to the requested medical records (e.g., medical records 14, 20) being accessible via e.g., provider computer 40, the requested medical records (e.g., medical records 14, 20) may be available via one or more mobile devices, examples of which may include but are not limited to personal digital assistant 42 and cellular telephone 44. As discussed above, personal digital assistant 42 and cellular telephone 44 may execute provider applications 56, 58 (respectively) to facilitate access to record management process 10, and view the medical records (e.g., medical records 14, 20) stored on e.g., management computer 12. Accordingly, medical services provider 36 may use personal digital assistant 42 to access e.g., image 150 of an X-ray (as shown in FIG. 3) included within the requested medical records (e.g., medical records 14, 20) and/or medical services provider 38 may use cellular telephone 44 to access image 200 of an X-ray (as shown in FIG. 4) included within the medical records (e.g., medical records 14, 20).

There may be occasions in which a medical services provider is looking for a medical record that is not currently available via data management process 10. For example, an indication that the medical record is available may be due to e.g., a radiology expert being listed as an image provider for a particular patient, although no such medical record is shown as being available. Accordingly, data management process 10 may allow the medical services provider to request the “missing” medical record (via e.g., electronic request 76). Data management process 10 may process 114 the received request and obtain 100, 102 the “missing” medical record by contacting the appropriate image server application (e.g., image server application 66, 72).

While data management process 10 is described above as being a stand-alone service, this is for illustrative purposes only and is not intended to be a limitation of this disclosure, as other configurations are possible. Specifically, data management process 10 may be a web service included within a larger system, such as a health information exchange software system.

A number of implementations have been described. Nevertheless, it will be understood that various modifications may be made. Accordingly, other implementations are within the scope of the following claims.

What is claimed is:

1. A computer-implemented method comprising:
obtaining a first medical record for a first patient from a first image provider within a health information exchange;
obtaining a second medical record for a second patient from a second image provider within the health information exchange; and
enabling the availability of the first medical record and the second medical record to a medical services provider.

2. The computer-implemented method of claim 1 further comprising:
requiring the medical services provider to authenticate their identity.

3. The computer-implemented method of claim 2 wherein enabling the availability includes:
enabling the availability of an electronic view of the first medical record and an electronic view of the second medical record to the medical services provider.

4. The computer-implemented method of claim 3 further comprising:
streaming the electronic view of the first medical record to the medical services provider.

5. The computer-implemented method of claim 3 further comprising:
streaming the electronic view of the second medical record to the medical services provider.

6. The computer-implemented method of claim 1 wherein obtaining the first medical record for the first patient includes:
retrieving the first medical record for the first patient via a first image server of the first image provider.

7. The computer-implemented method of claim 1 wherein obtaining the second medical record for the second patient includes:
retrieving the second set of medical records for the second patient via a second image server of the second image provider.

8. The computer-implemented method of claim 1 further comprising:
receiving a request for a third medical record for a third patient from a third image provider within the health information exchange.

9. The computer-implemented method of claim 8 further comprising:
processing the request for the third medical record for the third patient from the third image provider within the health information exchange.

10. The computer-implemented method of claim 9 further comprising:
obtaining the third medical record for the third patient from the third image provider within the health information exchange.

11. The computer-implemented method of claim 10 further comprising:
enabling the availability of the third medical record to the medical services provider.

12. The computer-implemented method of claim 1 wherein one or more of the first and second medical records is an image-based medical record.

13. The computer-implemented method of claim 1 wherein the medical services provider is chosen from the group consisting of: a general clinician; and a specialized clinician.

14. A computer program product residing on a computer readable medium having a plurality of instructions stored thereon that, when executed by a processor, cause the processor to perform operations comprising:
obtaining a first medical record for a first patient from a first image provider within a health information exchange;
obtaining a second medical record for a second patient from a second image provider within the health information exchange; and
enabling the availability of the first medical record and the second medical record to a medical services provider.

15. The computer program product of claim 14 further comprising instruction for:
requiring the medical services provider to authenticate their identity.

16. The computer program product of claim 15 wherein the instruction for enabling the availability include instruction for:
enabling the availability of an electronic view of the first medical record and an electronic view of the second medical record to the medical services provider.

17. The computer program product of claim 16 further comprising instruction for:
streaming the electronic view of the first medical record to the medical services provider.

18. The computer program product of claim 16 further comprising instruction for:
streaming the electronic view of the second medical record to the medical services provider.

19. The computer program product of claim 14 wherein the instruction for obtaining the first medical record for the first patient include instruction for:
retrieving the first medical record for the first patient via a first image server of the first image provider.

20. The computer program product of claim 14 wherein the instruction for obtaining the second medical record for the second patient include instruction for:
retrieving the second set of medical records for the second patient via a second image server of the second image provider.

21. The computer program product of claim 14 further comprising instruction for:
receiving a request for a third medical record for a third patient from a third image provider within the health information exchange.

22. The computer program product of claim 21 further comprising instruction for:
processing the request for the third medical record for the third patient from the third image provider within the health information exchange.

23. The computer program product of claim 22 further comprising instruction for:
obtaining the third medical record for the third patient from the third image provider within the health information exchange.

24. The computer program product of claim 23 further comprising instruction for:
enabling the availability of the third medical record to the medical services provider.

25. The computer program product of claim 14 wherein one or more of the first and second medical records is an image-based medical record.

26. The computer program product of claim 14 wherein the medical services provider is chosen from the group consisting of: a general clinician; and a specialized clinician.
